(19) United States
(12) Patent Application Publication
(10) Pub. No.: US 2024/0267949 A1
(43) Pub. Date: Aug. 8, 2024

(54) SYSTEMS AND METHODS FOR WI-FI PACKET DURATION CONTROL FOR IN-DEVICE COEXISTENCE (IDC) AMONG ASYNCHRONOUS RADIOS

(71) Applicant: Meta Platforms Technologies, LLC, Menlo Park, CA (US)

(72) Inventors: Ding Li, Fremont, CA (US); Neelakantan Nurani Krishnan, San Jose, CA (US); Guoqing Li, Cupertino, CA (US); Abhishek Kumar Agrawal, Bellevue, WA (US); Chao-Fang Shih, San Jose, CA (US)

(73) Assignee: Meta Platforms Technologies, LLC, Menlo Park, CA (US)

(21) Appl. No.: 18/398,736

(22) Filed: Dec. 28, 2023

Related U.S. Application Data
(60) Provisional application No. 63/442,907, filed on Feb. 2, 2023.

(51) Int. Cl. H04W 74/0816; H04W 24/08; H04W 74/08

(52) U.S. Cl. CPC H04W 74/0816; H04W 24/08; H04W 74/0866; H04W 84/12

(57) ABSTRACT

A first device may one or more processors. The one or more processors may be configured to monitor wireless receive (Rx) traffic to a second device. The one or more processors may be configured to generate, based on the wireless Rx traffic, control information to control wireless transmit (Tx) traffic from the first device to avoid collision between the wireless Rx traffic and the wireless Tx traffic, the control information including at least one of a maximum Tx frame duration or a minimum Tx inter-frame gap. The one or more processors may be configured to wirelessly transmit, via a transceiver based on the control information, the wireless Tx traffic in a wireless local area network (WLAN).

### CROSS-REFERENCE TO RELATED APPLICATION

This application claims priority to U.S. Provisional Patent Application No. 63/442,907 filed on Feb. 2, 2023, which is incorporated by reference herein in its entirety for all purposes.

### FIELD OF DISCLOSURE

The present disclosure is generally related to communications, including but not limited systems and methods for a wireless device to avoid collision between Wi-Fi and other radios by configuring Wi-Fi packet transmission/reception durations in an in-device coexistence environment (e.g., artificial reality environment).

### BACKGROUND

Artificial reality such as a virtual reality (VR), an augmented reality (AR), or a mixed reality (MR) provides immersive experience to a user. In one example, a user wearing a head wearable display (HWD) can turn the user's head, and an image of a virtual object corresponding to a location of the HWD and a gaze direction of the user can be displayed on the HWD to allow the user to feel as if the user is moving within a space of artificial reality (e.g., a VR space, an AR space, or a MR space). An image of a virtual object may be generated by a console communicatively coupled to the HWD. In some embodiments, the console may have access to a network.

### SUMMARY

Various embodiments disclosed herein are related to a first device including one or more processors. In some embodiments, the one or more processors may be configured to monitor wireless receive (Rx) traffic to a second device. The one or more processors may be configured to generate, based on the wireless Rx traffic, control information to control wireless transmit (Tx) traffic from the first device to avoid collision between the wireless Rx traffic and the wireless Tx traffic, the control information including at least one of a maximum Tx frame duration or a minimum Tx inter-frame gap. The one or more processors may be configured to wirelessly transmit, via a transceiver based on the control information, the wireless Tx traffic in a wireless local area network (WLAN).

In some embodiments, the maximum Tx frame duration may include a maximum Physical Layer Convergence Protocol (PLCP) protocol data unit (PPDU) and a maximum short interframe space (SIFS) burst duration. The minimum Tx inter-frame gap may be a minimum gap between two frames each having a frame duration smaller than or equal to the maximum Tx frame duration.

In some embodiments, in generating the control information, the one or more processors may be configured to determine an Rx frame duration and an Rx inter-frame gap relating to the wireless Rx traffic. The one or more processors may be configured to determine, as the control information, the maximum Tx frame duration and the minimum Tx inter-frame gap relating to the wireless Tx traffic such that the one or more frames transmitted using the maximum Tx frame duration and the minimum Tx inter-frame gap do not conflict with one or more frames transmitted using the Rx frame duration and the Rx inter-frame gap.

In some embodiments, the maximum Tx frame duration may be set to a difference between the Rx inter-frame gap and the Rx frame duration. The minimum Tx inter-frame duration may be set to a sum of the Rx inter-frame gap and the Rx frame duration.

Various embodiments disclosed herein are related to a first device including one or more processors. In some embodiments, the one or more processors may be configured to monitor wireless transmit (Tx) traffic from a second device. The one or more processors may be configured to generate a first frame including control information to control wireless receive (Rx) traffic to the first device to avoid collision between the wireless Tx traffic and the wireless Rx traffic. Each of the first device and the second device may not be an access point. The control information may include at least one of a maximum Rx frame duration or a minimum Rx inter-frame gap. The one or more processors may be configured to wirelessly transmit, via a transceiver, the generated first frame to an access point in a wireless local area network (WLAN).

In some embodiments, the first frame may include a control identifier field. In generating the first frame, the one or more processors may be configured to set the control identifier field to a value indicating a frame duration control frame. The control identifier field may be included in an aggregate control (A-control) subfield of a High Efficiency (HE) variant High Throughput (HT) control field of the first frame.

In some embodiments, the maximum Rx frame duration may include a maximum Physical Layer Convergence Protocol (PLCP) protocol data unit (PPDU) and a maximum short interframe space (SIFS) burst duration. The minimum Rx inter-frame gap may be a minimum gap between two frames each having a frame duration smaller than or equal to the maximum Rx frame duration.

In some embodiments, the one or more processors may be configured to monitor second wireless receive (Rx) traffic to the second device. The one or more processors may be configured to generate second control information to control second wireless Tx traffic from the first device to avoid collision between the second wireless Tx traffic and the second wireless Rx traffic, the second control information including at least one of a maximum Tx frame duration or a minimum Tx inter-frame gap. The one or more processors may be configured to include the second control information in the first frame. The maximum Tx frame duration may include a maximum Physical Layer Convergence Protocol (PLCP) protocol data unit (PPDU) and a maximum short interframe space (SIFS) burst duration. The minimum Tx inter-frame gap may be a minimum gap between two frames each having a frame duration smaller than or equal to the maximum Tx frame duration.

In some embodiments, in generating the second control information, the one or more processors may be configured to determine an Rx frame duration and an Rx inter-frame gap relating to the second wireless Rx traffic. The one or more processors may be configured to determine, as the second control information, the maximum Tx frame duration and the minimum Tx inter-frame gap relating to the second wireless Tx traffic such that the one or more frames transmitted using the maximum Tx frame duration and the minimum Tx inter-frame gap do not conflict with one or more frames transmitted using the Rx frame duration and the Rx inter-frame gap. The maximum Tx frame duration may be set to a difference between the Rx inter-frame gap and the Rx frame duration. The minimum Tx inter-frame duration may be set to a sum of the Rx inter-frame gap and the Rx frame duration.

Various embodiments disclosed herein are related to a method including monitoring, by a first device, wireless transmit (Tx) traffic from a second device. The method may include generating, by the first device, a first frame including control information to control wireless receive (Rx) traffic to the first device to avoid collision between the wireless Tx traffic and the wireless Rx traffic. Each of the first device and the second device may not be an access point. The control information may include at least one of a maximum Rx frame duration or a minimum Rx inter-frame gap. The method may include wirelessly transmitting, via a transceiver, the generated first frame to an access point in a wireless local area network (WLAN).

In some embodiments, the first frame may include a control identifier field. In generating the first frame, the first device may set the control identifier field to a value indicating a frame duration control frame. The control identifier field may be included in an aggregate control (A-control) subfield of a High Efficiency (HE) variant High Throughput (HT) control field of the first frame.

In some embodiments, the maximum Rx frame duration may include a maximum Physical Layer Convergence Protocol (PLCP) protocol data unit (PPDU) and a maximum short interframe space (SIFS) burst duration. The minimum Rx inter-frame gap may be a minimum gap between two frames each having a frame duration smaller than or equal to the maximum Rx frame duration.

In some embodiments, the first device may monitor second wireless receive (Rx) traffic to the second device. The first device may generate second control information to control second wireless Tx traffic from the first device to avoid collision between the second wireless Tx traffic and the second wireless Rx traffic, the second control information including at least one of a maximum Tx frame duration or a minimum Tx inter-frame gap. The first device may include the second control information in the first frame. The maximum Tx frame duration may include a maximum Physical Layer Convergence Protocol (PLCP) protocol data unit (PPDU) and a maximum short interframe space (SIFS) burst duration. The minimum Tx inter-frame gap may be a minimum gap between two frames each having a frame duration smaller than or equal to the maximum Tx frame duration.

In some embodiments, in generating the second control information, the first device may determine an Rx frame duration and an Rx inter-frame gap relating to the second wireless Rx traffic. The first device may determine, as the second control information, the maximum Tx frame duration and the minimum Tx inter-frame gap relating to the second wireless Tx traffic such that the one or more frames transmitted using the maximum Tx frame duration and the minimum Tx inter-frame gap do not conflict with one or more frames transmitted using the Rx frame duration and the Rx inter-frame gap. The maximum Tx frame duration may be set to a difference between the Rx inter-frame gap and the Rx frame duration. The minimum Tx inter-frame duration may be set to a sum of the Rx inter-frame gap and the Rx frame duration.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4A to FIG. 4C illustrate example in-device coexistence (IDC) traffic scenarios of a Wi-Fi device and another device, according to an example implementation of the present disclosure.

FIG. 5A to FIG. 5C illustrate examples of controlling packet durations for IDC traffic scenarios of a Wi-Fi device as an aggressor and another device as a victim, according to an example implementation of the present disclosure.

FIG. 6 illustrates an example IDC traffic scenario of a Wi-Fi device as a victim and another device as an aggressor, according to an example implementation of the present disclosure.

FIG. 7A to FIG. 7C illustrate one example of controlling packet durations for IDC traffic scenarios of a Wi-Fi device as a victim and another device as an aggressor, according to an example implementation of the present disclosure.

FIG. 8A to FIG. 8B illustrate another example of controlling packet durations for IDC traffic scenarios of a Wi-Fi device as a victim and another device as an aggressor, according to an example implementation of the present disclosure.

FIG. 9 is a flowchart showing a process of controlling packet durations for IDC among Wi-Fi devices, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

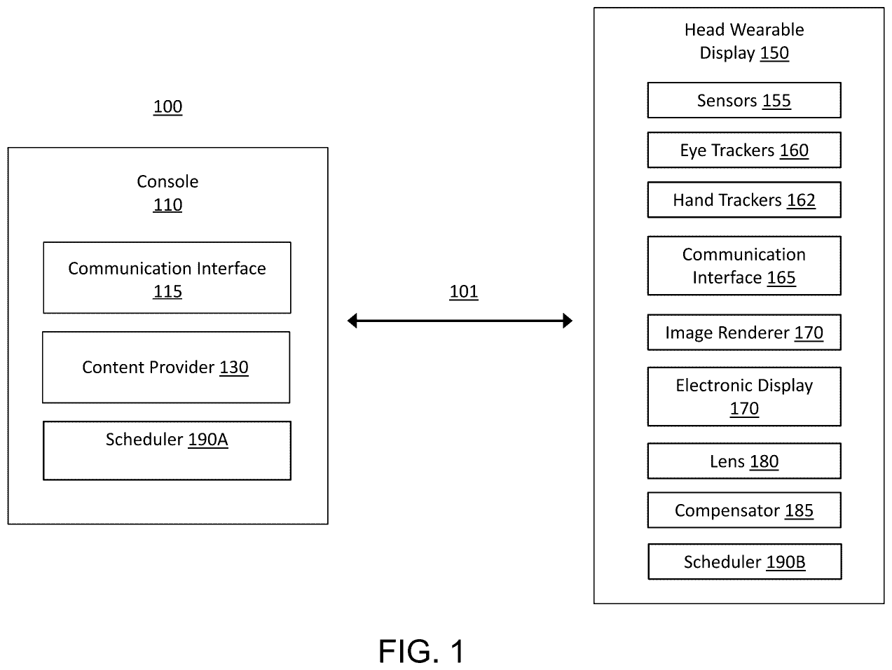

FIG. 1 is a block diagram of an example artificial reality system environment 100 in which a console 110 operates. FIG. 1 provides an example environment in which devices may communicate traffic streams with different latency sensitivities/requirements. In some embodiments, the artificial reality system environment 100 includes a HWD 150 worn by a user, and a console 110 providing content of artificial reality to the HWD 150. A head wearable display (HWD) may be referred to as, include, or be part of a head mounted display (HMD), head mounted device (HMD), head wearable device (HWD), head worn display (HWD) or head worn device (HWD). In one aspect, the HWD 150 may include various sensors to detect a location, an orientation, and/or a gaze direction of the user wearing the HWD 150, and provide the detected location, orientation and/or gaze direction to the console 110 through a wired or wireless connection. The HWD 150 may also identify objects (e.g., body, hand face).

The console 110 may determine a view within the space of the artificial reality corresponding to the detected location, orientation and/or the gaze direction, and generate an image depicting the determined view. The console 110 may also receive one or more user inputs and modify the image according to the user inputs. The console 110 may provide the image to the HWD 150 for rendering. The image of the space of the artificial reality corresponding to the user's view can be presented to the user. In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the console 110 may be performed by the HWD 150, and/or some of the functionality of the HWD 150 may be performed by the console 110.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the console 110, or both, and presents audio based on the audio information. In some embodiments, the HWD 150 includes sensors 155, eye trackers 160, a communication interface 165, an image renderer 170, an electronic display 175, a lens 180, and a compensator 185. These components may operate together to detect a location of the HWD 150 and/or a gaze direction of the user wearing the HWD 150, and render an image of a view within the artificial reality corresponding to the detected location of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and/or an orientation of the HWD 150. Examples of sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and/or the rotational movement, and determine an orientation and location of the HWD 150. In one aspect, the sensors 155 can detect the translational movement and/or the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the eye trackers 160 include electronic components or a combination of electronic components and software components that determine a gaze direction of the user of the HWD 150. In some embodiments, the HWD 150, the console 110 or a combination may incorporate the gaze direction of the user of the HWD 150 to generate image data for artificial reality. In some embodiments, the eye trackers 160 include two eye trackers, where each eye tracker 160 captures an image of a corresponding eye and determines a gaze direction of the eye. In one example, the eye tracker 160 determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker 160 may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers 160 incorporate the orientation of the HWD 150 and the relative gaze direction with respect to the HWD 150 to determine a gaze direction of the user. Assuming for an example that the HWD 150 is oriented at a direction 30 degrees from a reference direction, and the relative gaze direction of the HWD 150 is −10 degrees (or 350 degrees) with respect to the HWD 150, the eye trackers 160 may determine that the gaze direction of the user is 20 degrees from the reference direction. In some embodiments, a user of the HWD 150 can configure the HWD 150 (e.g., via user settings) to enable or disable the eye trackers 160. In some embodiments, a user of the HWD 150 is prompted to enable or disable the eye trackers 160.

In some embodiments, the hand tracker 162 includes an electronic component or a combination of an electronic component and a software component that tracks a hand of the user. In some embodiments, the hand tracker 162 includes or is coupled to an imaging sensor (e.g., camera) and an image processor that can detect a shape, a location and/or an orientation of the hand. The hand tracker 162 may generate hand tracking measurements indicating the detected shape, location and/or orientation of the hand.

In some embodiments, the communication interface 165 includes an electronic component or a combination of an electronic component and a software component that communicates with the console 110. The communication interface 165 may communicate with a communication interface 115 of the console 110 through a communication link. The communication link may be a wireless link, a wired link, or both. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In embodiments in which the console 110 and the head wearable display 150 are implemented on a single system, the communication interface 165 may communicate with the console 110 through a bus connection or a conductive trace. Through the communication link, the communication interface 165 may transmit to the console 110 sensor measurements indicating the determined location of the HWD 150, orientation of the HWD 150, the determined gaze direction of the user, and/or hand tracking measurements. Moreover, through the communication link, the communication interface 165 may receive from the console 110 sensor measurements indicating or corresponding to an image to be rendered.

Using the communication interface, the console 110 (or HWD 150) may coordinate operations on link 101 to reduce collisions or interferences. For example, the console 110 may coordinate communication between the console 110 and the HWD 150. In some implementations, the console 110 may transmit a beacon frame periodically to announce/advertise a presence of a wireless link between the console 110 and the HWD 150 (or between two HWDs). In an implementation, the HWD 150 may monitor for or receive the beacon frame from the console 110, and can schedule communication with the HWD 150 (e.g., using the information in the beacon frame, such as an offset value) to avoid collision or interference with communication between the console 110 and/or HWD 150 and other devices.

The console 110 and HWD 150 may communicate using link 101 (e.g., intralink). Data (e.g., a traffic stream) may flow in a direction on link 101. For example, the console 110 may communicate using a downlink (DL) communication to the HWD 150 and the HWD 150 may communicate using an uplink (UL) communication to the console 110.

In some embodiments, the image renderer 170 includes an electronic component or a combination of an electronic component and a software component that generates one or more images for display, for example, according to a change in view of the space of the artificial reality. In some embodiments, the image renderer 170 is implemented as a processor (or a graphical processing unit (GPU)) that executes instructions to perform various functions described herein. The image renderer 170 may receive, through the communication interface 165, data describing an image to be rendered, and render the image through the electronic display 175. In some embodiments, the data from the console 110 may be encoded, and the image renderer 170 may decode the data to generate and render the image. In one aspect, the image renderer 170 receives the encoded image from the console 110, and decodes the encoded image, such that a communication bandwidth between the console 110 and the HWD 150 can be reduced.

In some embodiments, the image renderer 170 receives, from the console, 110 additional data including object information indicating virtual objects in the artificial reality space and depth information indicating depth (or distances from the HWD 150) of the virtual objects. Accordingly, the image renderer 170 may receive from the console 110 object information and/or depth information. The image renderer 170 may also receive updated sensor measurements from the sensors 155. The process of detecting, by the HWD 150, the location and the orientation of the HWD 150 and/or the gaze direction of the user wearing the HWD 150, and generating and transmitting, by the console 110, a high resolution image (e.g., 1920 by 1080 pixels, or 2048 by 1152 pixels) corresponding to the detected location and the gaze direction to the HWD 150 may be computationally exhaustive and may not be performed within a frame time (e.g., less than 11 ms or 8 ms).

In some implementations, the image renderer 170 may perform shading, reprojection, and/or blending to update the image of the artificial reality to correspond to the updated location and/or orientation of the HWD 150. Assuming that a user rotated their head after the initial sensor measurements, rather than recreating the entire image responsive to the updated sensor measurements, the image renderer 170 may generate a small portion (e.g., 10%) of an image corresponding to an updated view within the artificial reality according to the updated sensor measurements, and append the portion to the image in the image data from the console 110 through reprojection. The image renderer 170 may perform shading and/or blending on the appended edges. Hence, without recreating the image of the artificial reality according to the updated sensor measurements, the image renderer 170 can generate the image of the artificial reality.

In other implementations, the image renderer 170 generates one or more images through a shading process and a reprojection process when an image from the console 110 is not received within the frame time. For example, the shading process and the reprojection process may be performed adaptively, according to a change in view of the space of the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the image renderer 170.

In some embodiments, the lens 180 is a mechanical component that alters received light from the electronic display 175. The lens 180 may magnify the light from the electronic display 175, and correct for optical error associated with the light. The lens 180 may be a Fresnel lens, a convex lens, a concave lens, a filter, or any suitable optical component that alters the light from the electronic display 175. Through the lens 180, light from the electronic display 175 can reach the pupils, such that the user can see the image displayed by the electronic display 175, despite the close proximity of the electronic display 175 to the eyes.

In some embodiments, the compensator 185 includes an electronic component or a combination of an electronic component and a software component that performs compensation to compensate for any distortions or aberrations. In one aspect, the lens 180 introduces optical aberrations such as a chromatic aberration, a pin-cushion distortion, barrel distortion, etc. The compensator 185 may determine a compensation (e.g., predistortion) to apply to the image to be rendered from the image renderer 170 to compensate for the distortions caused by the lens 180, and apply the determined compensation to the image from the image renderer 170. The compensator 185 may provide the predistorted image to the electronic display 175.

In some embodiments, the console 110 is an electronic component or a combination of an electronic component and a software component that provides content to be rendered to the HWD 150. In one aspect, the console 110 includes a communication interface 115 and a content provider 130. These components may operate together to determine a view (e.g., a field of view (FOV) of the user) of the artificial reality corresponding to the location of the HWD 150 and/or the gaze direction of the user of the HWD 150, and can generate an image of the artificial reality corresponding to the determined view. In other embodiments, the console 110 includes more, fewer, or different components than shown in FIG. 1. In some embodiments, the console 110 is integrated as part of the HWD 150. In some embodiments, the communication interface 115 is an electronic component or a combination of an electronic component and a software component that communicates with the HWD 150. The communication interface 115 may be a counterpart component to the communication interface 165 to communicate with a communication interface 115 of the console 110 through a communication link (e.g., USB cable, a wireless link). Through the communication link, the communication interface 115 may receive from the HWD 150 sensor measurements indicating the determined location and/or orientation of the HWD 150, the determined gaze direction of the user, and/or hand tracking measurements. Moreover, through the communication link, the communication interface 115 may transmit to the HWD 150 data describing an image to be rendered.

The content provider 130 can include or correspond to a component that generates content to be rendered according to the location and/or orientation of the HWD 150, the gaze direction of the user and/or hand tracking measurements. In one aspect, the content provider 130 determines a view of the artificial reality according to the location and orientation of the HWD 150 and/or the gaze direction of the user of the HWD 150. For example, the content provider 130 maps the location of the HWD 150 in a physical space to a location within an artificial reality space, and determines a view of the artificial reality space along a direction corresponding to an orientation of the HWD 150 and/or the gaze direction of the user from the mapped location in the artificial reality space.

The content provider 130 may generate image data describing an image of the determined view of the artificial reality space, and transmit the image data to the HWD 150 through the communication interface 115. The content provider may also generate a hand model (or other virtual object) corresponding to a hand of the user according to the hand tracking measurement, and generate hand model data indicating a shape, a location, and an orientation of the hand model in the artificial reality space.

In some embodiments, the content provider 130 generates metadata including motion vector information, depth information, edge information, object information, etc., associated with the image, and transmits the metadata with the image data to the HWD 150 through the communication interface 115. The content provider 130 may encode and/or encode the data describing the image, and can transmit the encoded and/or encoded data to the HWD 150. In some embodiments, the content provider 130 generates and provides the image to the HWD 150 periodically (e.g., every one second).

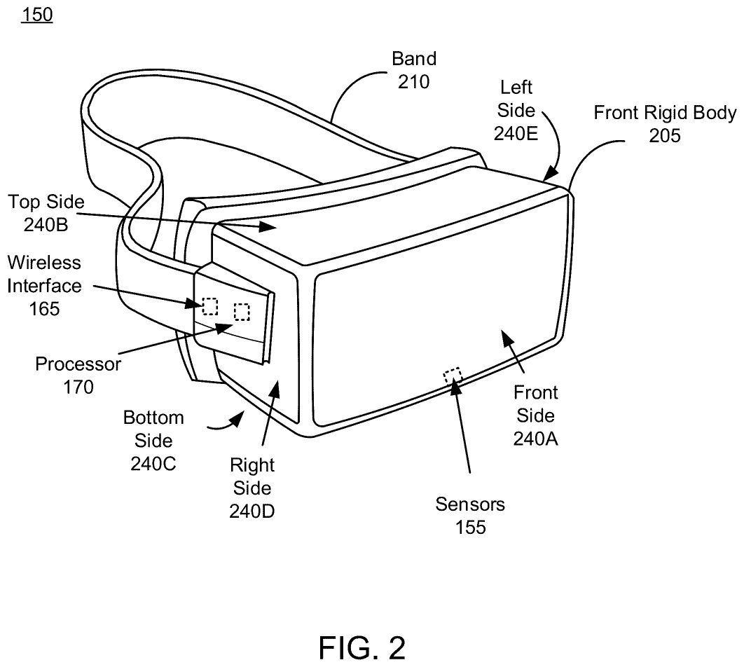

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens 180 (not shown in FIG. 2), the sensors 155, the eye trackers 160A, 160B, the communication interface 165, and the image renderer 170. In the embodiment shown by FIG. 2, the sensors 155 are located within the front rigid body 205, and may not visible to the user. In other embodiments, the HWD 150 has a different configuration than shown in FIG. 2. For example, the image renderer 170, the eye trackers 160A, 160B, and/or the sensors 155 may be in different locations than shown in FIG. 2.

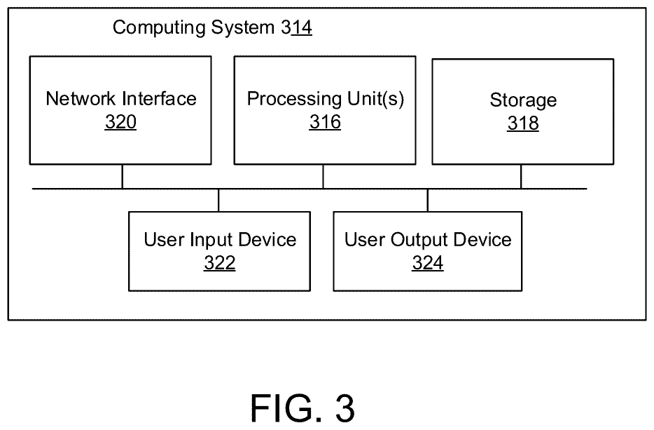

Various operations described herein can be implemented on computer systems. FIG. 3 shows a block diagram of a representative computing system 314 usable to implement the present disclosure. In some embodiments, the console 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 320 may include a transceiver to allow the computing system 314 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 316. Similarly, a receiver may be configured to receive frames, slots or symbols and the processor unit 316 may be configured to process the frames. For example, the processor unit 316 can be configured to determine a type of frame and to process the frame and/or fields of the frame accordingly.

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

In one aspect, wireless technologies (e.g., Wi-Fi, Bluetooth (BT)/Bluetooth Low Energy (BLE), cellular, Ultra-wideband (UWB), etc.) may be used for VR/AR devices in multiple domains that can support premium VR/AR experience, for example, data connectivity, motion tracking and ranging based location. Challenges may arise when multiple radios are integrated into a form factor with limited space. In various forms, different radios may interfere with each other and lead to poor user experience due to wireless performance degradation in terms of throughput, packet error rate, latency and/or jitter, etc. Therefore, a comprehensive and efficient design for multi-radio coexistence management becomes beneficial as a potential product differentiating point in VR/AR space.

One coexistence management technique that has been widely used (e.g., Wi-Fi/BT Coex in 2.4 GHz) is the time division multiplexing (TDM) based approach. However, this technique uses a real time coordination among radios, which is usually based on synchronous signals/messages over certain types of hardware interfaces like general-purpose input/output (GPIO)/Wireless Coexistence Interface 2 (WCI-2)/System Power Management Interface (SPMI). Adding such extra hardware interfaces like GPIO/UART/WCI-2/SPMI may increase the cost. Moreover, there can be a lot of cases where such interfaces might not be available for various reasons, for example, using chipset from different vendors, cost control, etc. An enhanced coexistence management design/scheme/technique among asynchronous radios that can solve these problems would be beneficial.

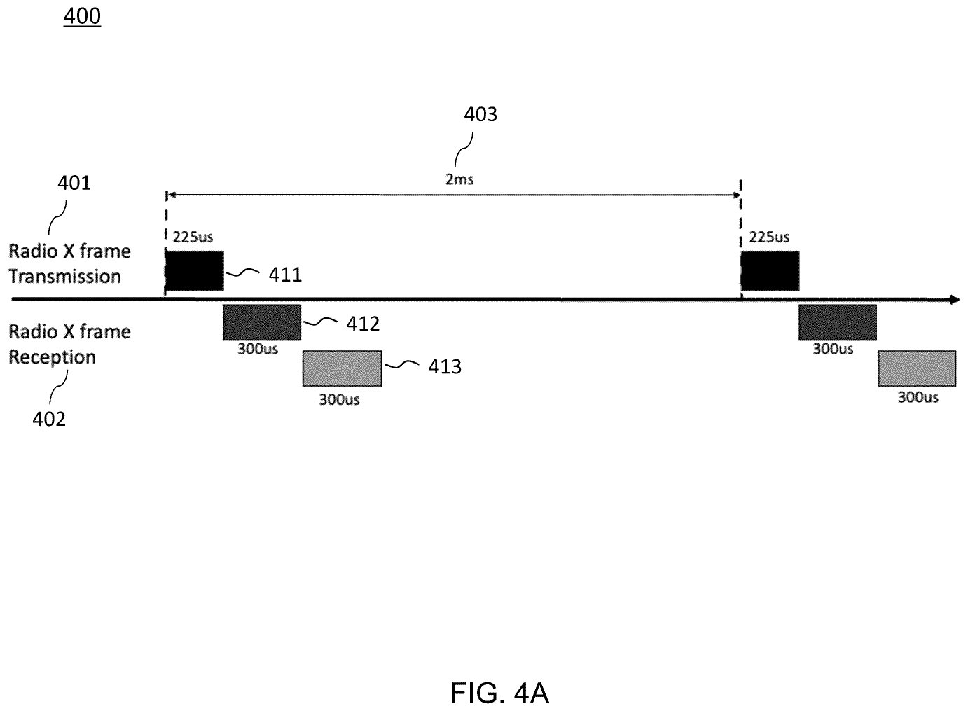

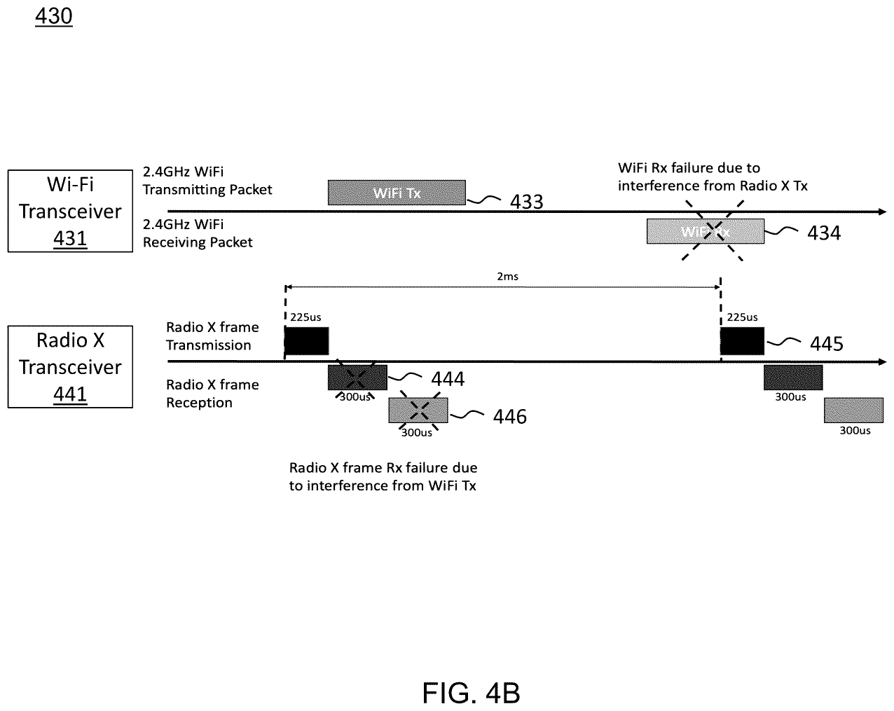

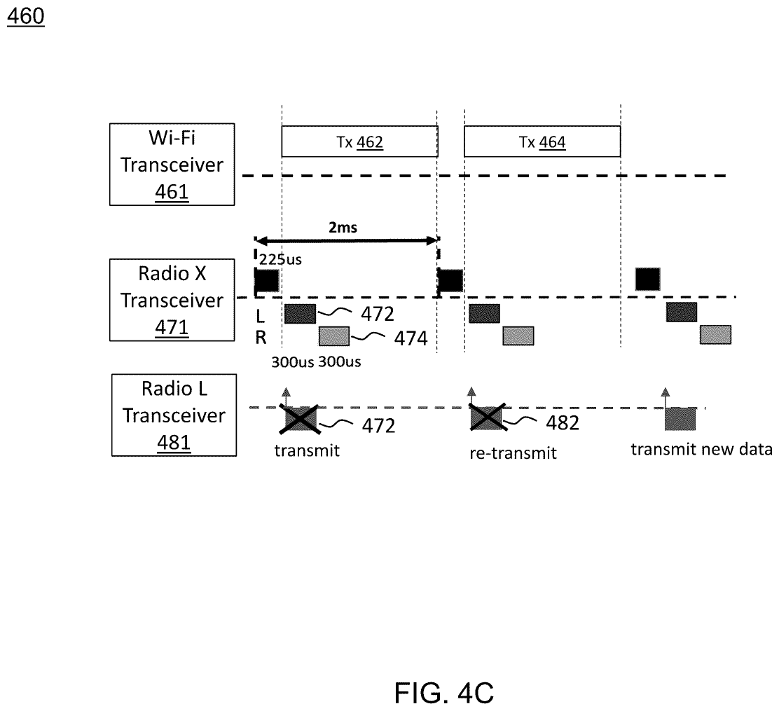

FIG. 4A to FIG. 4C illustrate example in-device coexistence (IDC) traffic scenarios of a Wi-Fi device and another Wi-Fi device (referred to as “radio X device”, “radio X”, “device X”, or “radio X transceiver”), according to an example implementation of the present disclosure. FIG. 4A shows an example traffic pattern 400 of a device X. For example, the traffic pattern 400 may have an interval 403 of 2 ms. Each interval may start with the device X transmitting 401 a frame 411 of 225 μs (e.g., transmission from a HWD to accessories (or controllers)), followed by the device X receiving 402 two frames 412, 413 of duration 300 μs back to back (e.g., transmission from two accessories (or controllers) to HWD). The received frames 412, 413 can be from accessories that work in pairs (e.g., a left controller and a right controller).

FIG. 4B shows an example scenario of IDC traffic between a Wi-Fi device or transceiver 431 and a radio X transceiver 441. Traffic from/to the transceiver 431 and traffic from/to the radio X transceiver 441 may be asynchronous, thus collision between the transceivers may occur. The Wi-Fi transceiver 431 and the radio X transceiver 441 may operate over the same frequency band over a spectrum. The frequency band may be, for example, 2.4 GHz ISM band. However, embodiments in the present disclosure may apply other frequency bands with similar IDC problems. As shown in FIG. 4B, the transmission from an aggressor (either the transceiver 431 or the radio X transceiver 441) can cause significant interference to a victim receiving a packet (either the radio X transceiver 441 or the transceiver 431). Referring to FIG. 4B, transmission of a packet 433 from the transceiver 431 (aggressor) may cause interference to the radio X transceiver 441 (victim) receiving packets 444, 446 of duration 300 μs. On the other hand, transmission of packet 445 of duration 225 μs from the radio X transceiver 441 (aggressor) may cause interference to the transceiver 431 (victim) receiving a packet 434.

FIG. 4C shows an example scenario of IDC traffic among a Wi-Fi device or transceiver 461 (as an aggressor), a radio X transceiver 471 (as a victim), and another transceiver 481 (as another victim). For example, the radio X transceiver 471 may be a HWD, and the transceiver 481 may be a left device of a pair of accessories (referred to as “radio L device” or “radio L transceiver”). Referring to FIG. 4C, in a 2 ms interval, the radio X transceiver 471 may receive two packets 472, 474 independently from the radio L transceiver 481 and a right device of the pair of accessories, respectively. In some embodiments, the immediately following interval may be reserved for retransmission of the two packets 472, 474. For example, the radio X transceiver 471 may experience packet loss of the packet 472 due to the reception of the packet 472 hit by (e.g., colliding with) transmission 462 by the transceiver 461. In response, the radio L may retransmit a packet 482, however, the radio X transceiver 471 may experience packet loss again due to the reception of the packet 482 hit by another transmission 464 by the transceiver 461.

To address these problems, in an in-device coexistence scenario in which devices with asynchronous radios (e.g., VR/AR devices) transmit or receive traffic independently, a method/system may leverage the configurability of Wi-Fi physical layer protocol data unit (PPDU)/short interframe space (SIFS) bursting duration in both uplink (UL) and downlink (DL) in MAC layer, in order to avoid back to back collision between Wi-Fi and other radios. In some embodiments, a method/system may perform signaling using a new control ID type in the Aggregated Control (A-Control) subfield in the High Efficiency (HE) variation of High Throughput (HT) Control field. In some embodiments, a method/system may use the Block Ack (BA) window size configuration to control the downlink PPDU/SIFS bursting duration. These embodiments may apply to coexistence with one radio, but can be extended to coexistence with more than one radios, as well as non-coexistence area such as duty cycle control in general. In some embodiments, the method/system may control packet durations using traffic patterns shown in FIG. 4A to FIG. 4C as example traffic patterns; however, the embodiments are not limited by the specific traffic patterns (of a Wi-Fi device, radio X device, or radio L device). The method/system according to some embodiments may be applicable to other traffic patterns.

In one approach, to address IDC scenarios in which a Wi-Fi device (whose Wi-Fi MAC settings can be configurable) is an aggressor and another radio X device (whose Wi-Fi MAC settings may not be configurable) is a victim, a system can limit (e.g., confine, reduce) a maximum Wi-Fi transmit (Tx) PPDU/SIFS bursting duration to less than or equal to a certain duration (e.g., less than or equal to a duration in a range of 2 ms-300 ms) depending on a traffic pattern of the radio X device. In some embodiments, the system can control (e.g., set, configure, adjust) a minimum Tx gap between Wi-Fi Tx PPDUs/Bursts to be greater than or equal to a certain duration (e.g., to be at least 2 ms+300 ms) depending on a traffic pattern of the radio X device.

For example, referring to FIG. 4C, since the Wi-Fi transceiver 461 and the radio X transceiver 471 are asynchronous, collision between the two transceivers may occur. In some embodiments, a system can avoid consecutive collisions of an receive (Rx) packet of the radio X transceiver 471 (e.g., Rx packets 472 and 482 transmitted or retransmitted by the radio L device 481 hit by Tx packets 462 and 464 transmitted by the Wi-Fi transceiver 461) by controlling Wi-Fi PPDU durations of the Wi-Fi transceiver 461, so that retransmission of the Rx packet of the radio X transceiver 471 (e.g., retransmitted packet 482) can help recover the packet loss due to the initial collision.

In some embodiments, the system can control (e.g., configure, set, adjust) Tx packet durations of a Wi-Fi device (as an aggressor) to avoid consecutive collisions of an Rx packet of another device (e.g., radio X device as a victim). In some embodiments, a method/system can avoid consecutive collisions of an Rx packet of the radio X device with one or more Tx packets of the Wi-Fi device by configuring Wi-Fi MAC settings to limit a Wi-Fi Tx PPDU/SIFS Burst duration to be less than or equal to a certain duration (e.g., less than a duration in a range of 2 ms-300 ms, for instance). In some embodiments, the system may set (e.g., adjust, configure) a maximum duration of the Wi-Fi Tx PPDU/SIFS bursting duration to a difference between an interval between Tx packets and a frame duration of the Tx packets. For example, if the Wi-Fi device transmits Tx packets of a frame duration of 0.3 ms with an interval of 2 ms therebetween, the system may set a maximum duration of the Wi-Fi PPDU/SIFS burst duration (of the Wi-Fi device) to 1.7 ms (=2.0 ms-0.3 ms). In other words, the system can set the Wi-Fi PPDU/SIFS burst duration to less than or equal to 1.7 ms (≤1.7 ms), to avoid consecutive collisions of Rx packets of the radio X device with Tx packets of the Wi-Fi device. In some embodiments, the system can limit (e.g., reduce, decrease, confine, set, configure, adjust) the maximum duration of a Wi-Fi PPDU/SIFS burst duration of the Wi-Fi device by controlling (e.g., configuring, setting, programming) Wi-Fi MAC settings of the Wi-Fi device by firmware, software, and/or hardware of the Wi-Fi device.

In some embodiments, the system can control (e.g., configure, set, adjust) a gap (e.g., inter-frame gap or inter-frame duration/space) between Tx packets of a Wi-Fi device (as an aggressor) to avoid consecutive collisions of an Rx packet of another device (e.g., radio X device as a victim). In some embodiments, a method/system can avoid consecutive collisions of an Rx packet of the radio X device with one or more Tx packets of the Wi-Fi device by configuring Wi-Fi MAC settings to control (e.g., configure, set, adjust) a minimum Tx gap between Wi-Fi Tx PPDUs/SIFS bursting to be greater than or equal to a certain duration (e.g., at least 2 ms+300 ms for instance). In some embodiments, the system may set (e.g., adjust, configure) a minimum Tx gap between Wi-Fi Tx PPDUs/SIFS bursting to a sum of an interval between Tx packets and a frame duration of the Tx packets. For example, if the Wi-Fi device transmits Tx packets of a frame duration of 0.3 ms with an interval of 2 ms therebetween, the system may set a minimum Tx gap between Wi-Fi Tx PPDUs/SIFS bursting (of the Wi-Fi device) to 2.3 ms (=2.0 ms+0.3 ms). In other words, the system can set the Tx gap between Wi-Fi Tx PPDUs/SIFS bursts to greater than or equal to 2.3 ms (≥2.3 ms), to avoid consecutive collisions of Rx packets of the radio X device with Tx packets of the Wi-Fi device. In some embodiments, the system can set (e.g., configure, adjust) the minimum Tx gap between Wi-Fi Tx PPDUs/SIFS bursts of the Wi-Fi device by controlling (e.g., configuring, setting, programming) Wi-Fi MAC settings of the Wi-Fi device by (1) normal Wi-Fi channel access latency and/or (2) firmware, software, and/or hardware of the Wi-Fi device.

In some embodiments, the reduction of the maximum duration of a Wi-Fi PPDU/SIFS burst duration or the increase of the minimum Tx gap between Wi-Fi Tx PPDUs/SIFS bursts may incur an extra media contention overhead due to shorter PPDU/SIFS bursts. However, such extra media contention overhead may be small and may not cause much changes to the Wi-Fi duty cycle. Thus, the average probability of collision between the Wi-Fi device and the radio X device may not increase.

In another approach, the system/method can avoid collision of Rx packets (or downlink (DL) packets) of a Wi-Fi device as a victim (whose Wi-Fi MAC settings can be configurable) with Tx packets of another radio X device as an aggressor (whose Wi-Fi MAC settings may not be configurable). For example, an Rx PPDU/SIFS burst duration of the victim Wi-Fi device may conflict (e.g., collide, overlap) with a Tx packet transmitted by the aggressor radio X device. To address this IDC collision scenario, in some embodiments, a system can decrease the impact of Tx packets of the radio X device (on Rx packets of the Wi-Fi device) when receiving a Wi-Fi PPDU by controlling Wi-Fi Rx (or downlink) PPDU/SIFS burst durations of the Wi-Fi device. In some embodiments, the system can decrease the impact of Tx packets of the radio X device on Rx packets of the Wi-Fi device by (1) indirectly controlling a Block Ack window size based on the current modulation and coding scheme (MCS) (indirect method) and/or (2) defining a new signaling to decrease Rx PPDU duration (direct method).

In some embodiments, the system/method can configure (e.g., set, adjust, control, change) Wi-Fi MAC parameter settings of the Wi-Fi device to decrease a Rx PPDU duration (or Rx PPDU/SIFS bursting duration) to decrease the impact of Tx packets of the radio X device on Rx packets of the Wi-Fi device. In some embodiments, during a Block Ack session establishment (or setup), an originator (e.g., a device that can send a packet to the Wi-Fi device as a recipient) may generate an Add Block Ack (ADDBA) request frame including a Block Ack Parameter Set field (e.g., 4th field in the frame format of the ADDBA request frame), set a buffer size subfield (e.g., Block Ack window size subfield, or number of buffers subfield) to a buffer size corresponding to a desired frame size, and can send the ADDBA request frame to the Wi-Fi device as the recipient. In response to the ADDBA request, the Wi-Fi device may send an ACK frame to the originator, may generate an ADDBA response frame including a Block Ack Parameter Set field, may set a buffer size subfield (e.g., Block Ack window size subfield, or number of buffers subfield) to a buffer size corresponding to a desired Rx PPDU duration, and can send the ADDBA response frame to the originator. In some embodiments, the Wi-Fi device can calculate a buffer size (e.g., Block Ack (BA) window size) corresponding to a desired Rx PPDU duration using the following equation:

$$PPDU duration \leq \frac{max\_MPDU \_size * BA\_window \_size + MAC\_overhead + PHY\_overhead}{Current\_MCS \_Rate} \qquad ( Equation 1 )$$

For example, Assuming MAC_overhead=PHY_overhead=0; and max MPDU_size=3 k bytes, if current_MCS_rate is 250 Mbps, the Wi-Fi device can set the Block Ack Window Size subfield to 6 to achieve the PPDU duration<=1.6 ms. If current_MCS_rate is 60 Mbps, the Wi-Fi device can set the Block Ack Window Size subfield to 4 to achieve the PPDU duration<=1.6 ms.

In response to the ADDBA response, the originator may send an ACK frame to the recipient to confirm the buffer size set to the desired Rx PPDU duration. From then on, the originator may transmit a block of QoS data frames separated by SIFS period, with the total number of frames not exceeding the buffer size subfield value in the associated ADDBA Response frame (e.g., the desired Rx PPDU duration), and can send a BlockAckReq frame to the Wi-Fi device. In response to the BlockAckReq frame, the Wi-Fi device may send a BlockAck frame to the originator. In some embodiments, responsive to changes of the current MCS, the Wi-Fi device (as the recipient) can send a Delete Block Ack (DELBA) frame to terminate the current BA agreement and can set up a new BA agreement with a new BA window size (using a new Block Ack session establishment/setup). In response to the DELBA frame, the Wi-Fi device may send an ACK frame to the originator to confirm the termination of the current BA agreement.

In some embodiments, the system/method can control (e.g., configure, set, adjust, change) a Rx (or DL) PPDU/SIFS bursting duration by defining a new signaling procedure. Using the new signaling procedure, the system/method can not only control the Rx (or DL) PPDU/SIFS bursting duration but can also control the Tx (or UP) PPDU/SIFS bursting duration, a Tx gap (e.g., a gap between Tx packets), and an Rx gap (e.g., a gap between Rx packets). In some embodiments, the new signaling procedure can allow a device to configure (1) maximum Rx PPDU duration, (2) minimum Rx PPDU gap, (3) maximum Rx SIFS bursting duration, (4) maximum Tx PPDU duration, (5) minimum Tx PPDU gap, and/or (6) maximum Tx SIFS bursting duration. In some embodiments, an aggregate control (A-control) subfield of a High Efficiency (HE) variant High Throughput (HT) control field for configuring PPDU/SIFS bursting durations can be defined. The A-control subfield may include the fields of a plurality of HE controls (including HE control-1, HE control-2, . . . , HE control-N) and a padding. Each HE control may include the fields of control ID and control information. For PPDU/SIFS bursting duration control, the control ID field may be set to a value (e.g., 7) indicating PPDU/SIFS burst duration (PSBD). The control information field (or PSBD control field) may include the subfields of maximum Rx PPDU duration, minimum Rx PPDU gap, maximum Rx SIFS bursting duration, maximum Tx PPDU duration, minimum Tx PPDU gap, and/or maximum Tx SIFS bursting duration. In some embodiments, duration value 1 used in the subfields may represent 0.5 ms. Some embodiments of the present disclosure define a new signaling to configure PPDU/SIFS bursting duration using the A-control subfield; however, the embodiments of the present disclosure are not limited to the use of the A-control subfield and other fields or elements can be used for signaling to control PPDU/SIFS bursting duration.

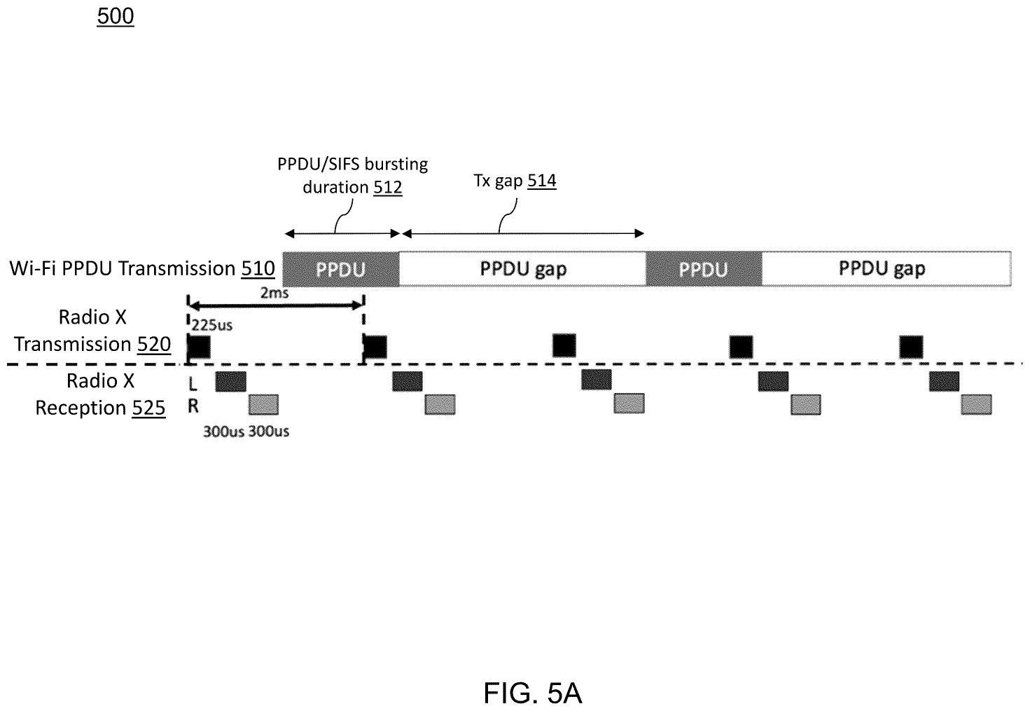

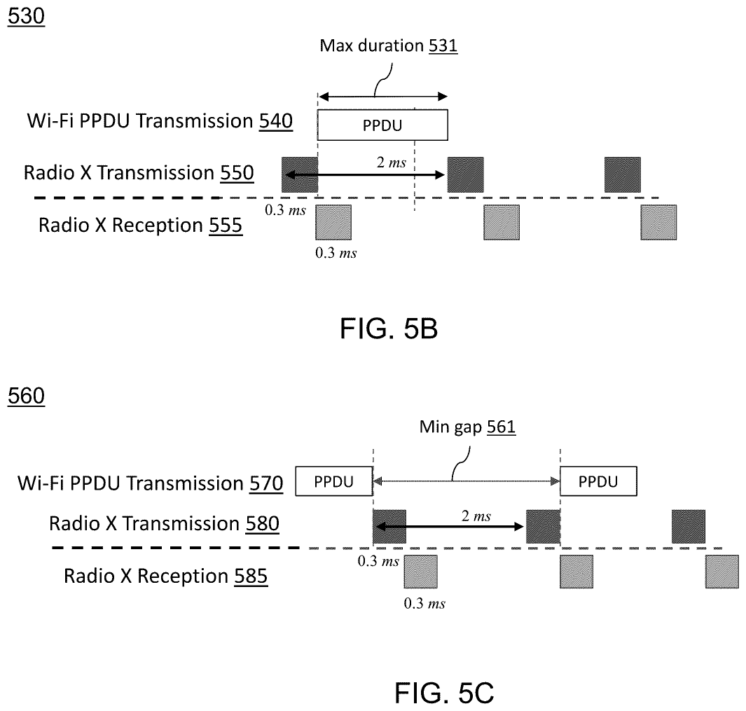

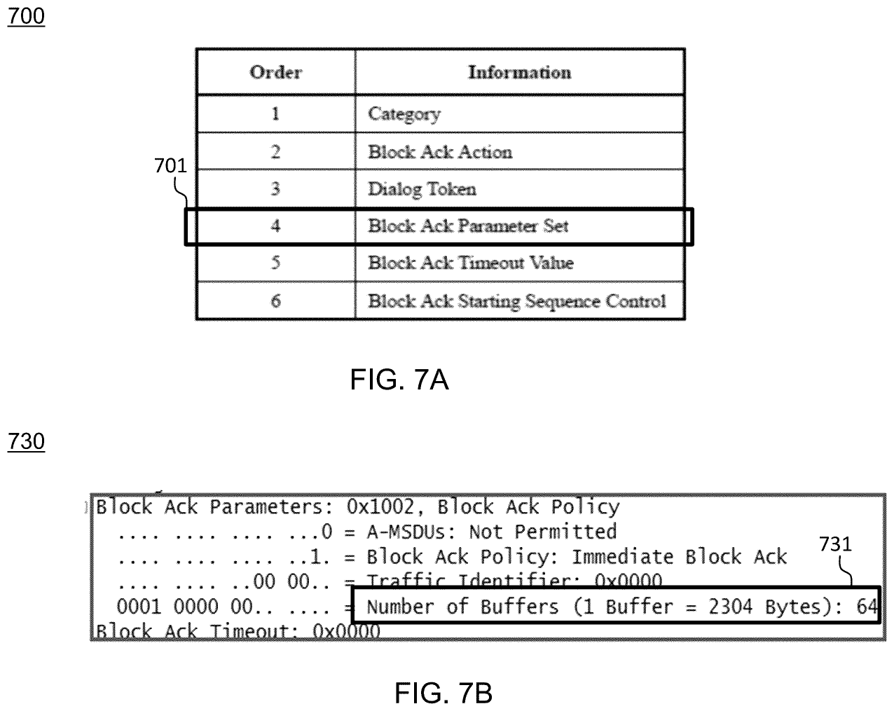

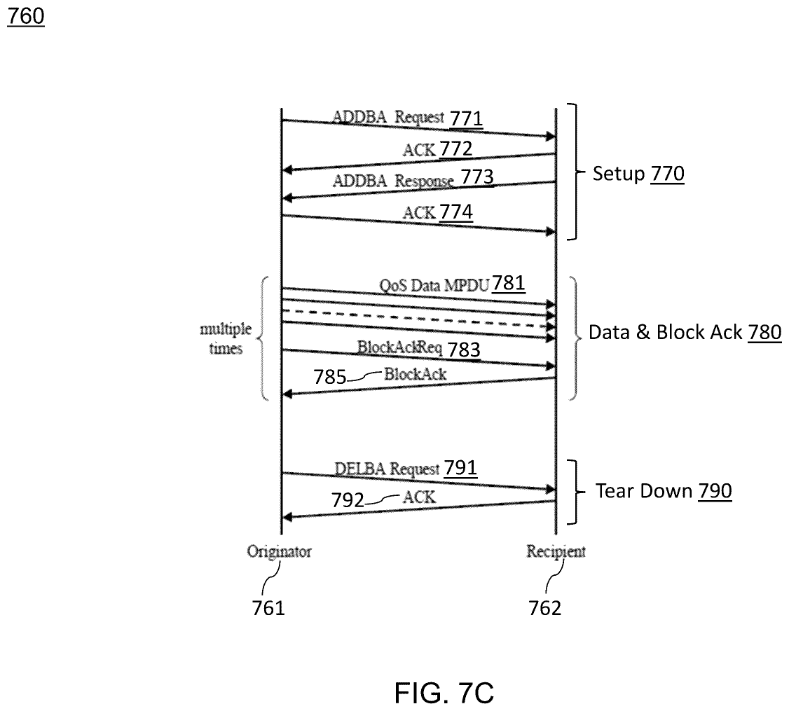

In some embodiments, the Wi-Fi device can (1) monitor traffic to/from another device (e.g., radio X device which is not an access point) (2) generate a PSBD frame including the subfields of maximum Rx PPDU duration, minimum Rx PPDU gap, maximum Rx SIFS bursting duration, maximum Tx PPDU duration, minimum Tx PPDU gap, and/or maximum Tx SIFS bursting duration, (2) set the subfields to desired duration/gap values (e.g., desired values of maximum Rx PPDU duration, minimum Rx PPDU gap, maximum Rx SIFS bursting duration, maximum Tx PPDU duration, minimum Tx PPDU gap, and/or maximum Tx SIFS bursting duration) to avoid collisions between the traffic to/from the Wi-Fi device and the traffic to/from the radio X device, and (4) send the PSBD frame to the access point. In response to the PSBD frame, the access point may send an ACK frame to the Wi-Fi device to confirm the desired duration/gap values. Once the agreement is reached, the Wi-Fi device and the access point can exchange frames using the agreed duration/gap values. If no agreement is reached, the Wi-Fi device may use a different method to configure duration/gap values (e.g., setting a maximum Tx duration or a minimum Tx gap by configuring Wi-Fi MAC settings as shown in FIG. 5A to FIG. 5C, setting a maximum Rx duration using the Block Ack setup as shown in FIG. 7A to FIG. 7C).

Embodiments in the present disclosure have at least the following advantages and benefits. Embodiments in the present disclosure can provide useful techniques for managing in-device coexistence among devices with asynchronous radios, e.g., VR/AR devices. Systems and methods according to some embodiments can manage IDS among asynchronous radio devices by controlling Wi-Fi packet durations without adding extra hardware interfaces like GPIO/UART/WCI-2/SPMI, thereby providing enhanced and cost-efficient coexistence management design/scheme/technique.

FIG. 5A to FIG. 5C illustrates examples of controlling packet durations for IDC traffic scenarios of a Wi-Fi device as an aggressor and another device (e.g., radio X device) as a victim, according to an example implementation of the present disclosure. For example, referring to FIG. 4C, since the Wi-Fi transceiver 461 and the radio X transceiver 471 are asynchronous, collision between the two transceivers may occur. In some embodiments, a system can avoid consecutive collisions of an Rx packet of the radio X transceiver 471 (e.g., Rx packets 472 and 482 transmitted or retransmitted by the radio L device 481 hit by Tx packets 462 and 464 transmitted by the Wi-Fi transceiver 461) by controlling Wi-Fi PPDU durations of the Wi-Fi transceiver 461, so that retransmission of the Rx packet of the radio X transceiver 471 (e.g., retransmitted packet 482) can help recover the packet loss due to the initial collision. In an IDC traffic scenario 500 shown in FIG. 5A, the system can control (e.g., configure, set, change, adjust) a PPDU/SIFS burst duration 512 and/or a Tx gap 514 to avoid collision between PPDU transmission 510 of the Wi-Fi device (as an aggressor) and receptions 525 of the radio X device (as a victim) while transmission 520 of the radio X device being performed.

FIG. 5B shows a block diagram 530 of controlling a maximum Tx PPDU/SIFS burst duration 531 in the IDC traffic scenario of FIG. 5A in which the Wi-Fi device (whose Wi-Fi MAC settings can be configurable) is an aggressor and the radio X device (whose Wi-Fi MAC settings may not be configurable) is a victim. The system can limit (e.g., confine, reduce) a maximum Wi-Fi Tx PPDU/SIFS burst duration 531 to less than or equal to a certain duration (e.g., less than or equal to a duration in a range of 2 ms-300 ms) depending on a traffic pattern of the radio X device. The system can control (e.g., configure, set, adjust) Tx packet durations of the Wi-Fi device (as an aggressor) to avoid consecutive collisions of receptions 555 of the radio X device (as a victim) with transmission 540 of the Wi-Fi device by configuring Wi-Fi MAC settings to limit the Wi-Fi Tx PPDU/SIFS Burst duration 531 to be less than or equal to a difference between an interval between Tx packets in the transmission 550 of the radio X device and a frame duration of the Tx packets. For example, if the Wi-Fi device transmits Tx packets of a frame duration of 0.3 ms with an interval of 2 ms therebetween, the system may set the maximum duration 531 of the Wi-Fi PPDU/SIFS bursting duration (of the Wi-Fi device) to 1.7 ms (=2.0 ms-0.3 ms). In some embodiments, the system can limit (e.g., reduce, decrease, confine, set, configure, adjust) the maximum duration 531 of a Wi-Fi PPDU/SIFS burst duration of the Wi-Fi device by controlling (e.g., configuring, setting, programming) Wi-Fi MAC settings of the Wi-Fi device by firmware, software, and/or hardware of the Wi-Fi device.

FIG. 5C shows a block diagram 560 of controlling a minimum Tx gap 561 between Tx packets in the transmission 570 of the Wi-Fi device. The system can control (e.g., set, configure, adjust) the minimum Tx gap 561 between Wi-Fi Tx PPDUs/Bursts to be greater than or equal to a certain duration (e.g., to be at least 2 ms+300 ms) depending on a traffic pattern of the radio X device. The system can control (e.g., configure, set, adjust) a gap (e.g., inter-frame gap or inter-frame duration/space) between Tx packets in the transmission 570 of the Wi-Fi device (as an aggressor) to avoid consecutive collisions of the reception 585 of the radio X device (as a victim). The system can avoid consecutive collisions of an Rx packet in the reception 585 of the radio X device with the transmission 570 of the Wi-Fi device by configuring Wi-Fi MAC settings to control (e.g., configure, set, adjust) the minimum Tx gap 561 between Wi-Fi Tx PPDUs/SIFS bursts to be greater than or equal to a certain duration (e.g., at least 2 ms+300 ms for instance). The system may set (e.g., adjust, configure) the minimum Tx gap 561 between Wi-Fi Tx PPDUs/SIFS bursts to a sum of an interval between Tx packets in the transmission 580 of the radio X device and a frame duration of the Tx packets. For example, if the Wi-Fi device transmits Tx packets of a frame duration of 0.3 ms with an interval of 2 ms therebetween, the system may set the minimum Tx gap 561 to 2.3 ms (=2.0 ms+0.3 ms). In other words, the system can set the Tx gap 561 between Wi-Fi Tx PPDUs/SIFS bursts to greater than or equal to 2.3 ms (≥2.3 ms), to avoid consecutive collisions of Rx packets of the radio X device with Tx packets of the Wi-Fi device. The system can set (e.g., configure, adjust) the minimum Tx gap 561 between Wi-Fi Tx PPDUs/SIFS bursts of the Wi-Fi device by controlling (e.g., configuring, setting, programming) Wi-Fi MAC settings of the Wi-Fi device by (1) normal Wi-Fi channel access latency and/or (2) firmware, software, and/or hardware of the Wi-Fi device.

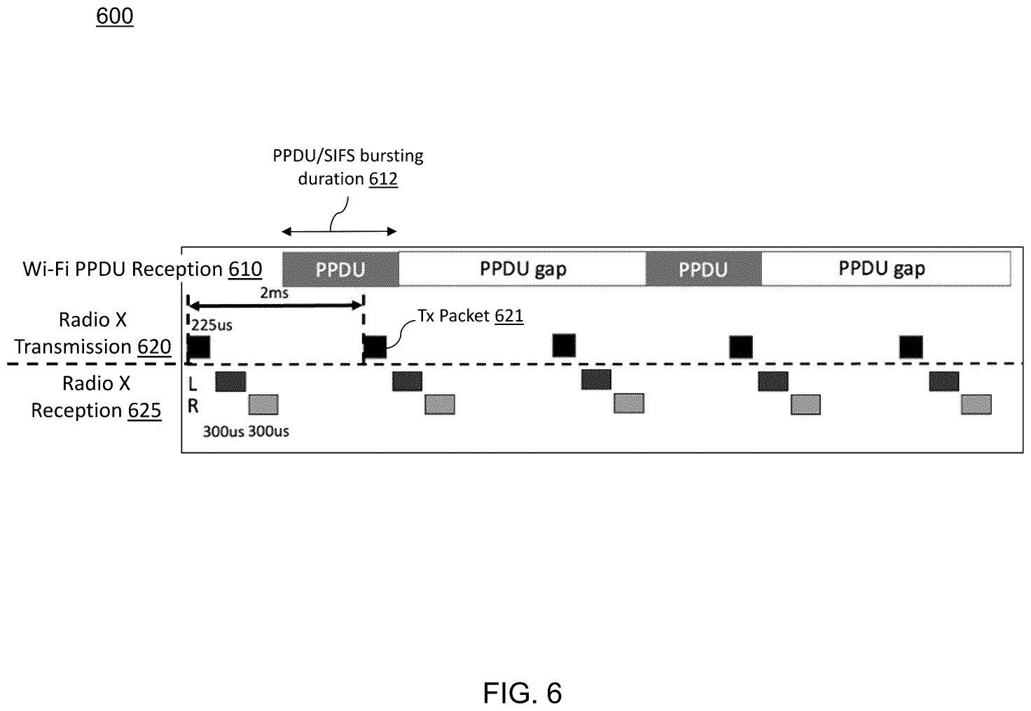

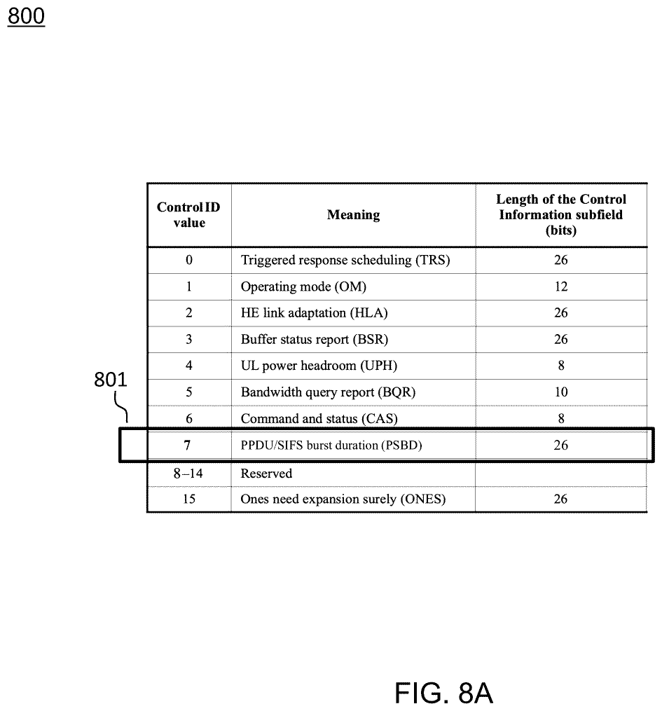

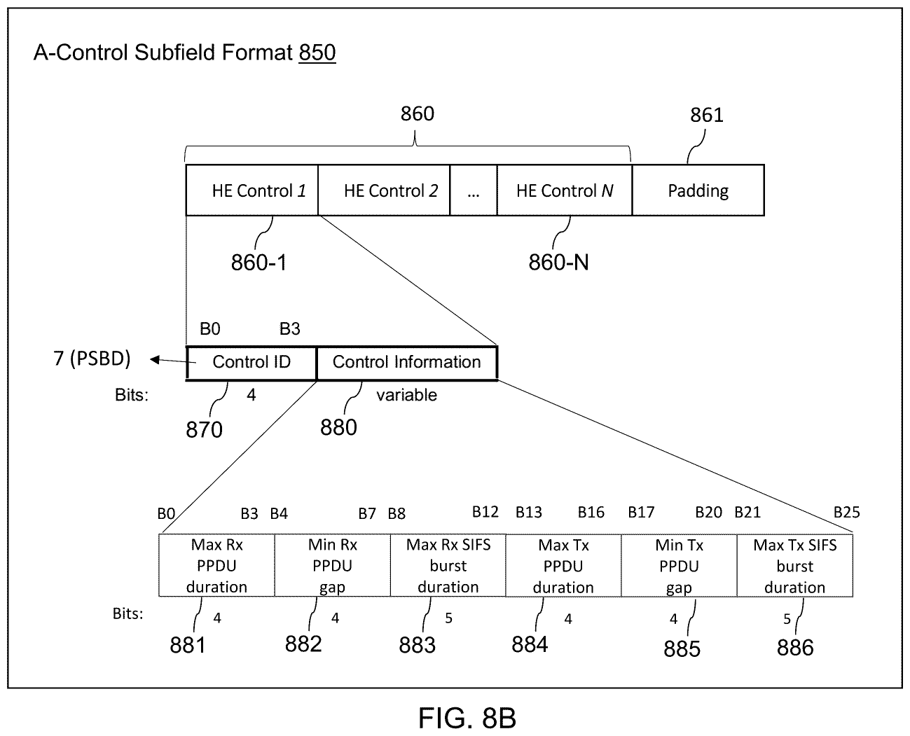

FIG. 6 illustrates an example IDC traffic scenario 600 of a Wi-Fi device as a victim and another device (e.g., radio X device) as an aggressor, according to an example implementation of the present disclosure. As shown in FIG. 6, an Rx PPDU/SIFS burst duration 612 of the victim Wi-Fi device may conflict (e.g., collide, overlap) with a Tx packet 621 transmitted by the aggressor radio X device. To address this IDC collision scenario, a system can decrease the impact of Tx packets in the transmission 620 of the radio X device on Rx packets in the reception 610 of the Wi-Fi device when receiving a Wi-Fi PPDU while reception 620 of the radio X device being performed. In some embodiments, the system can decrease the impact of Tx packets of the radio X device on Rx packets of the Wi-Fi device by (1) indirectly controlling a Block Ack window size based on the current modulation and coding scheme (MCS) (indirect method; see FIG. 7A to FIG. 7C) and/or (2) defining a new signaling to decrease Rx PPDU duration (direct method; see FIG. 8A to FIG. 8B).

FIG. 7A to FIG. 7C illustrate one example of controlling packet durations for IDC traffic scenarios of a Wi-Fi device as a victim and another device as an aggressor, according to an example implementation of the present disclosure. FIG. 7A shows a frame format 700 of an Add Block Ack (ADDBA) request frame. FIG. 7B show a format 730 of a Block Ack Parameter Set field 701 in the ADDBA request frame 700. FIG. 7C illustrates a diagram of controlling packet durations during a Block Ack session setup process 770, during a data transmission and Block Ack process 780, and during a tear down process 790.

Referring to FIG. 7A to FIG. 7C, the system can configure (e.g., set, adjust, control, change) Wi-Fi MAC parameter settings of the Wi-Fi device to decrease a Rx PPDU duration (or Rx PPDU/SIFS burst duration) to decrease the impact of Tx packets (e.g., Tx packet 621) of the radio X device on Rx packets (e.g., Rx PPDU/SIFS bursting duration 612) of the Wi-Fi device. During the Block Ack session establishment (or setup) process 779, an originator 761 (e.g., a device that can send a packet to the Wi-Fi device as a recipient) may generate an ADDBA request frame 771 including a Block Ack Parameter Set field 701, set a buffer size subfield 731 (e.g., Block Ack window size subfield, or number of buffers subfield) of the Block Ack Parameter Set field 730 to a buffer size corresponding to a desired Rx PPDU/SIFS burst duration, and can send the ADDBA request frame 771 to the Wi-Fi device 762 as the recipient. In response to the ADDBA request, the Wi-Fi device 762 may send an ACK frame 772 to the originator 761, generate an ADDBA response frame 773 including a Block Ack Parameter Set field, set a buffer size subfield 731 (e.g., Block Ack window size subfield, or number of buffers subfield) of the Block Ack Parameter Set field 730 to a buffer size corresponding to a desired Rx PPDU duration, and send the ADDBA response frame 773 to the originator 761. The Wi-Fi device can calculate a buffer size (e.g., Block Ack (BA) window size) corresponding to a desired Rx PPDU duration using Equation 1.

In response to the ADDBA response 773, the originator 761 may send an ACK frame 774 to the recipient 762 (e.g., Wi-Fi device) to confirm the buffer size set to the desired Rx PPDU duration. From then on, during the data and Block Ack process 780, the originator 761 may transmit a block of QoS data frames 781 separated by SIFS period, with the total number of frames not exceeding the buffer size subfield value in the associated ADDBA Response frame 773 (e.g., the desired Rx PPDU duration), and send a BlockAckReq frame 783 to the Wi-Fi device 762. In response to the BlockAckReq frame 783, the Wi-Fi device 762 may send a BlockAck frame 785 to the originator 761.

Responsive to changes of the current MCS, for example, the Wi-Fi device 762 (as the recipient) can send a Delete Block Ack (DELBA) frame 791 in the tear down process 790 to terminate the current BA agreement and set up a new BA agreement with a new BA window size (using a new Block Ack session establishment/setup). In response to the DELBA frame 791, the Wi-Fi device may send an ACK frame 792 to the originator to confirm the termination of the current BA agreement.

FIG. 8A to FIG. 8B illustrates another example of controlling packet durations for IDC traffic scenarios of a Wi-Fi device as a victim and another device as an aggressor, according to an example implementation of the present disclosure. FIG. 8A shows values 800 of control ID subfield in an aggregate control (A-control) subfield of a High Efficiency (HE) variant High Throughput (HT) control field, according to an example implementation of the present disclosure. FIG. 8B shows a format 850 of the A-control subfield for controlling packet durations, according to an example implementation of the present disclosure.

Referring to 8A to FIG. 8B, a system/method can control (e.g., configure, set, adjust, change) a Rx (or DL) PPDU/SIFS burst duration by defining a new signaling procedure. Using the new signaling procedure, the system/method can not only control the Rx (or DL) PPDU/SIFS burst duration but also control the Tx (or UP) PPDU/SIFS burst duration, a Tx gap (e.g., a gap between Tx packets), and an Rx gap (e.g., a gap between Rx packets). In some embodiments, the new signaling procedure can allow a device (e.g., Wi-Fi device) to configure (1) maximum Rx PPDU duration, (2) minimum Rx PPDU gap, (3) maximum Rx SIFS bursting duration, (4) maximum Tx PPDU duration, (5) minimum Tx PPDU gap, and/or (6) maximum Tx SIFS burst duration. In some embodiments, the A-control subfield 850 of the HE variant HT control field for configuring PPDU/SIFS burst durations can be defined to include the fields of a plurality of HE controls 860 (including HE control-1 860-1, HE control-2 860-2, . . . , HE control-N 860-N) and a padding 861. Each HE control may include the fields of control ID 870 and control information 880. For PPDU/SIFS burst duration control, the control ID field 870 may be set to a value (e.g., 7) indicating PPDU/SIFS burst duration (PSBD) 801. The control information field 880 (or PSBD control field) may include the subfields of maximum Rx PPDU duration 881, minimum Rx PPDU gap 882, maximum Rx SIFS burst duration 883, maximum Tx PPDU duration 884, minimum Tx PPDU gap 885, maximum Tx SIFS burst duration 886. In some embodiments, duration value 1 used in the subfields may represent 0.5 ms.

In some embodiments, the Wi-Fi device can (1) monitor traffic to/from another device (e.g., radio X device which is not an access point) (2) generate a PSBD frame including the subfields of maximum Rx PPDU duration 881, minimum Rx PPDU gap 882, maximum Rx SIFS burst duration 883, maximum Tx PPDU duration 884, minimum Tx PPDU gap 885, maximum Tx SIFS burst duration 886, (2) set the subfields to desired duration/gap values (e.g., desired values of maximum Rx PPDU duration, minimum Rx PPDU gap, maximum Rx SIFS burst duration, maximum Tx PPDU duration, minimum Tx PPDU gap, and/or maximum Tx SIFS burst duration) to avoid collisions between the traffic to/from the Wi-Fi device and the traffic to/from the radio X device, and (4) send the PSBD frame to the access point. In response to the PSBD frame, the access point may send an ACK frame to the Wi-Fi device to confirm the desired duration/gap values. Once the agreement is reached, the Wi-Fi device and the access point can exchange frames using the agreed duration/gap values. If no agreement is reached, the Wi-Fi device may use a different method to configure duration/gap values (e.g., setting a maximum Tx duration or a minimum Tx gap by configuring Wi-Fi MAC settings as shown in FIG. 5A to FIG. 5C, setting a maximum Rx duration using the Block Ack setup as shown in FIG. 7A to FIG. 7C).

In one approach, a first device (e.g., Wi-Fi device/transceiver 431) may one or more processors (e.g., processor 316). The one or more processors may be configured to monitor wireless receive (Rx) traffic (e.g., receptions 555, 585 in FIG. 5B and FIG. 5C) to a second device (e.g., radio X device/transceiver 441). The one or more processors may be configured to generate, based on the wireless Rx traffic, control information to control wireless transmit (Tx) traffic from the first device (e.g., transmissions 540, 570 in FIG. 5B and FIG. 5C) to avoid collision between the wireless Rx traffic (e.g., receptions 555, 585) and the wireless Tx traffic (e.g., transmissions 540, 570), the control information including at least one of a maximum Tx frame duration (e.g., maximum duration 531) or a minimum Tx inter-frame gap (e.g., minimum gap 561). The one or more processors may be configured to wirelessly transmit, via a transceiver based on the control information, the wireless Tx traffic in a wireless local area network (WLAN).

In some embodiments, the maximum Tx frame duration (e.g., maximum duration 531) may include a maximum Physical Layer Convergence Protocol (PLCP) protocol data unit (PPDU) and a maximum short interframe space (SIFS) burst duration. The minimum Tx inter-frame gap (e.g., minimum gap 561) may be a minimum gap between two frames each having a frame duration smaller than or equal to the maximum Tx frame duration.

In some embodiments, in generating the control information, the one or more processors may be configured to determine an Rx frame duration (e.g., 0.3 ms duration of an Rx frame in the reception 555) and an Rx inter-frame gap (e.g., 2 ms gap or interval between Rx frames in the reception 555) relating to the wireless Rx traffic. The one or more processors may be configured to determine, as the control information, the maximum Tx frame duration and the minimum Tx inter-frame gap relating to the wireless Tx traffic such that the one or more frames transmitted using the maximum Tx frame duration and the minimum Tx inter-frame gap do not conflict with one or more frames transmitted using the Rx frame duration and the Rx inter-frame gap.

In some embodiments, the maximum Tx frame duration (e.g., 1.7 ms) may be set to a difference between the Rx inter-frame gap (e.g., 2 ms) and the Rx frame duration (e.g., 0.3 ms). The minimum Tx inter-frame duration (e.g., 2.3 ms) may be set to a sum of the Rx inter-frame gap (e.g., 2 ms) and the Rx frame duration (e.g., 0.3 ms).

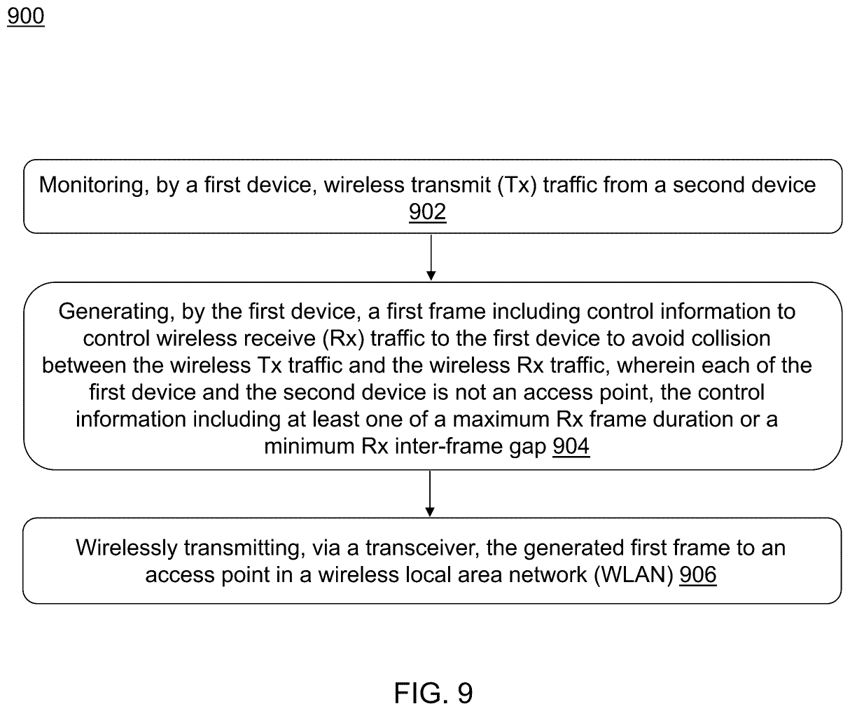

FIG. 9 is a flowchart showing a process 900 of controlling packet durations for IDC among Wi-Fi devices (e.g., Wi-Fi device/transceiver 461, radio X device/transceiver 471, radio L device/transceiver 481), according to an example implementation of the present disclosure. In some embodiments, the process 900 is performed by a first device (e.g., Wi-Fi device/transceiver 461). In some embodiments, the process 900 is performed by other entities. In some embodiments, the process 900 includes more, fewer, or different steps than shown in FIG. 9.

In one approach, the first device may monitor 902 wireless transmit (Tx) traffic (e.g., Tx traffic 620) from a second device (e.g., radio X device/transceiver 471).

In one approach, the first device (e.g., Wi-Fi device/transceiver 461) may generate 904 a first frame (e.g., a PSBD frame including the A-control subfield 850) including control information (e.g., PSBD control information 880) to control wireless receive (Rx) traffic (e.g., Rx traffic 610) to the first device to avoid collision between the wireless Tx traffic and the wireless Rx traffic (e.g., Rx traffic 610). Each of the first device and the second device may not be an access point. The control information may include at least one of a maximum Rx frame duration (e.g., maximum Rx PPDU duration 881) or a minimum Rx inter-frame gap (e.g., minimum Rx PPDU gap 882). In some embodiments, the maximum Rx frame duration may include a maximum Physical Layer Convergence Protocol (PLCP) protocol data unit (PPDU) and a maximum short interframe space (SIFS) burst duration (e.g., maximum Rx SIFS burst duration 884). The minimum Rx inter-frame gap may be a minimum gap between two frames each having a frame duration smaller than or equal to the maximum Rx frame duration.

In some embodiments, the first frame may include a control identifier field (e.g., control ID field 870). In generating the first frame, the first device may set the control identifier field to a value indicating a frame duration control frame (e.g., value 7 indicating PPDU/SIFS burst duration (PSBD) 801). The control identifier field may be included in the aggregate control (A-control) subfield 850 of a HE variant HT control field of the first frame.

In some embodiments, the first device may monitor second wireless receive (Rx) traffic (e.g., Rx traffic 555, 585 in FIG. 5B and FIG. 5C) to the second device (e.g., radio X device/transceiver). The first device may generate second control information to control second wireless Tx traffic (e.g., transmission 540, 570 in FIG. 5B and FIG. 5C) from the first device (e.g., Wi-Fi device) to avoid collision between the second wireless Tx traffic (e.g., transmission 540, 570) and the second wireless Rx traffic (e.g., Rx traffic 555, 585), the second control information including at least one of a maximum Tx frame duration (e.g., maximum Tx PPDU duration 884) or a minimum Tx inter-frame gap (e.g., minimum Tx PPDU gap 885). The first device may include the second control information in the first frame. The maximum Tx frame duration may include a maximum Physical Layer Convergence Protocol (PLCP) protocol data unit (PPDU) and a maximum short interframe space (SIFS) burst duration (e.g., maximum Tx SIFS burst duration 886). The minimum Tx inter-frame gap may be a minimum gap between two frames each having a frame duration smaller than or equal to the maximum Tx frame duration.

In some embodiments, in generating the second control information, the first device may determine an Rx frame duration (e.g., 0.3 ms duration of an Rx packet in the reception 555, 585) and an Rx inter-frame gap relating (e.g., 2.0 ms gap/interval between Rx packets in the reception 555, 585) to the second wireless Rx traffic. The first device may determine, as the second control information, the maximum Tx frame duration and the minimum Tx inter-frame gap relating to the second wireless Tx traffic such that the one or more frames transmitted using the maximum Tx frame duration and the minimum Tx inter-frame gap do not conflict with one or more frames transmitted using the Rx frame duration and the Rx inter-frame gap. The maximum Tx frame duration (e.g., 1.7 ms) may be set to a difference between the Rx inter-frame gap (e.g., 2.0 ms) and the Rx frame duration (e.g., 0.3 ms). The minimum Tx inter-frame duration (e.g., 2.3 ms) may be set to a sum of the Rx inter-frame gap (e.g., 2.0 ms) and the Rx frame duration (e.g., 0.3 ms).

In one approach, the first device may wirelessly transmit 906, via a transceiver, the generated first frame (e.g., the PSBD frame including the A-control subfield 850) to an access point in a WLAN.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A first device comprising:
one or more processors configured to:
monitor wireless receive (Rx) traffic to a second device;
generate, based on the wireless Rx traffic, control information to control wireless transmit (Tx) traffic from the first device to avoid collision between the wireless Rx traffic and the wireless Tx traffic, the control information including at least one of a maximum Tx frame duration or a minimum Tx inter-frame gap; and
wirelessly transmit, via a transceiver based on the control information, the wireless Tx traffic in a wireless local area network (WLAN).

2. The first device according to claim 1, wherein:
the maximum Tx frame duration includes a maximum Physical Layer Convergence Protocol (PLCP) protocol data unit (PPDU) and a maximum short interframe space (SIFS) burst duration, and
the minimum Tx inter-frame gap is a minimum gap between two frames each having a frame duration smaller than or equal to the maximum Tx frame duration.

3. The first device according to claim 1, wherein in generating the control information, the one or more processors are configured to:
determine an Rx frame duration and an Rx inter-frame gap relating to the wireless Rx traffic; and
determine, as the control information, the maximum Tx frame duration and the minimum Tx inter-frame gap relating to the wireless Tx traffic such that the one or more frames transmitted using the maximum Tx frame duration and the minimum Tx inter-frame gap do not conflict with one or more frames transmitted using the Rx frame duration and the Rx inter-frame gap.

4. The first device according to claim 1, wherein:
the maximum Tx frame duration is set to a difference between the Rx inter-frame gap and the Rx frame duration, and
the minimum Tx inter-frame duration is set to a sum of the Rx inter-frame gap and the Rx frame duration.

5. A first device comprising:
one or more processors configured to:
monitor wireless transmit (Tx) traffic from a second device;
generate a first frame including control information to control wireless receive (Rx) traffic to the first device to avoid collision between the wireless Tx traffic and the wireless Rx traffic, wherein each of the first device and the second device is not an access point, the control information including at least one of a maximum Rx frame duration or a minimum Rx inter-frame gap; and
wirelessly transmit, via a transceiver, the generated first frame to an access point in a wireless local area network (WLAN).

6. The first device according to claim 5, wherein:
the first frame includes a control identifier field, and
in generating the first frame, the one or more processors are configured to set the control identifier field to a value indicating a frame duration control frame.

7. The first device according to claim 6, wherein the control identifier field is included in an aggregate control (A-control) subfield of a High Efficiency (HE) variant High Throughput (HT) control field of the first frame.

8. The first device according to claim 5, wherein:
the maximum Rx frame duration includes a maximum Physical Layer Convergence Protocol (PLCP) protocol data unit (PPDU) and a maximum short interframe space (SIFS) burst duration, and
the minimum Rx inter-frame gap is a minimum gap between two frames each having a frame duration smaller than or equal to the maximum Rx frame duration.

9. The first device according to claim 5, wherein the one or more processors are configured to:
monitor second wireless receive (Rx) traffic to the second device;
generate second control information to control second wireless Tx traffic from the first device to avoid collision between the second wireless Tx traffic and the second wireless Rx traffic, the second control information including at least one of a maximum Tx frame duration or a minimum Tx inter-frame gap; and
include the second control information in the first frame.

10. The first device according to claim 9, wherein:
the maximum Tx frame duration includes a maximum Physical Layer Convergence Protocol (PLCP) protocol data unit (PPDU) and a maximum short interframe space (SIFS) burst duration, and
the minimum Tx inter-frame gap is a minimum gap between two frames each having a frame duration smaller than or equal to the maximum Tx frame duration.

11. The first device according to claim 9, wherein in generating the second control information, the one or more processors are configured to:
determine an Rx frame duration and an Rx inter-frame gap relating to the second wireless Rx traffic; and
determine, as the second control information, the maximum Tx frame duration and the minimum Tx inter-frame gap relating to the second wireless Tx traffic such that the one or more frames transmitted using the maximum Tx frame duration and the minimum Tx inter-frame gap do not conflict with one or more frames transmitted using the Rx frame duration and the Rx inter-frame gap.

12. The first device according to claim 11, wherein:
the maximum Tx frame duration is set to a difference between the Rx inter-frame gap and the Rx frame duration, and
the minimum Tx inter-frame duration is set to a sum of the Rx inter-frame gap and the Rx frame duration.

13. A method comprising:
monitoring, by a first device, wireless transmit (Tx) traffic from a second device;
generating, by the first device, a first frame including control information to control wireless receive (Rx) traffic to the first device to avoid collision between the wireless Tx traffic and the wireless Rx traffic, wherein each of the first device and the second device is not an access point, the control information including at least one of a maximum Rx frame duration or a minimum Rx inter-frame gap; and
wirelessly transmitting, via a transceiver, the generated first frame to an access point in a wireless local area network (WLAN).

14. The method according to claim 13, wherein:
the first frame includes a control identifier field, and
generating the first frame comprises setting the control identifier field to a value indicating a frame duration control frame.

15. The method according to claim 14, wherein the control identifier field is included in an aggregate control (A-control) subfield of a High Efficiency (HE) variant High Throughput (HT) control field of the first frame.

16. The method according to claim 13, wherein:
the maximum Rx frame duration includes a maximum Physical Layer Convergence Protocol (PLCP) protocol data unit (PPDU) and a maximum short interframe space (SIFS) burst duration, and
the minimum Rx inter-frame gap is a minimum gap between two frames each having a frame duration smaller than or equal to the maximum Rx frame duration.

17. The method according to claim 13, further comprising:
monitoring, by the first device, second wireless receive (Rx) traffic to the second device;
generating, by the first device, second control information to control second wireless Tx traffic from the first device to avoid collision between the second wireless Tx traffic and the second wireless Rx traffic, the second control information including at least one of a maximum Tx frame duration or a minimum Tx inter-frame gap; and
including, by the first device, the second control information in the first frame.

18. The method according to claim 17, wherein:
the maximum Tx frame duration includes a maximum Physical Layer Convergence Protocol (PLCP) protocol data unit (PPDU) and a maximum short interframe space (SIFS) burst duration, and
the minimum Tx inter-frame gap is a minimum gap between two frames each having a frame duration smaller than or equal to the maximum Tx frame duration.

19. The method according to claim 17, wherein generating the second control information comprises:
determining an Rx frame duration and an Rx inter-frame gap relating to the second wireless Rx traffic; and
determining, as the second control information, the maximum Tx frame duration and the minimum Tx inter-frame gap relating to the second wireless Tx traffic such that the one or more frames transmitted using the maximum Tx frame duration and the minimum Tx inter-frame gap do not conflict with one or more frames transmitted using the Rx frame duration and the Rx inter-frame gap.

20. The method according to claim 19, wherein:
the maximum Tx frame duration is set to a difference between the Rx inter-frame gap and the Rx frame duration, and
the minimum Tx inter-frame duration is set to a sum of the Rx inter-frame gap and the Rx frame duration.
